(19) United States
(12) Patent Application Publication
(10) Pub. No.: US 2026/0358739 A1
(43) Pub. Date: Nov. 12, 2026

(54) IMAGE FORMING APPARATUS

(71) Applicants: Arinobu Yoshiura, Kanagawa (JP); Takamasa Hase, Kanagawa (JP); Daisuke Inoue, Tokyo (JP); Nozomi Yunoki, Kanagawa (JP); Shogo Nakamoto, Kanagawa (JP); Ryohhei Sugiyama, Kanagawa (JP)

(72) Inventors: Arinobu Yoshiura, Kanagawa (JP); Takamasa Hase, Kanagawa (JP); Daisuke Inoue, Tokyo (JP); Nozomi Yunoki, Kanagawa (JP); Shogo Nakamoto, Kanagawa (JP); Ryohhei Sugiyama, Kanagawa (JP)

(73) Assignee: ETRIA Co., Ltd., Kanagawa (JP)

(21) Appl. No.: 19/652,031

(22) Filed: Apr. 20, 2026

(30) Foreign Application Priority Data
May 9, 2025 (JP) 2025-078762

(51) Int. Cl. G03G 15/00; G03G 15/20; G03G 21/02

(52) U.S. Cl. CPC G03G 15/553; G03G 15/2053; G03G 15/2064; G03G 15/5079; G03G 21/02; G03G 2215/2035

(57) ABSTRACT

An image forming apparatus includes: a rotating member; a pressure roller pressed against the rotating member to form a nip between the rotating member and the pressure roller to convey a medium in a conveyance direction; a heater in the rotating member to heat the rotating member; a temperature sensor disposed, in a width direction orthogonal to the conveyance direction, outside a passing region through which a medium having a smallest usable width in the image forming apparatus passes; circuitry configured to: store width groups of the media defined by a width of the medium in the width direction; determine the width groups to which the width of the medium passing through the nip belongs; and count a number of media passing through the nip in each of the width groups.

### CROSS-REFERENCE TO RELATED APPLICATIONS

This patent application is based on and claims priority pursuant to 35 U.S.C. § 119 (a) to Japanese Patent Application No. 2025-078762, filed on May 9, 2025, in the Japan Patent Office, the entire disclosure of which is hereby incorporated by reference herein.

### BACKGROUND

### Technical Field

The present disclosure relates to an image forming apparatus

### Related Art

The image forming apparatus includes a fixing device. Since components in the fixing device, such as a pressure roller that is a pressing member, deteriorate as the components are used, the components are replaced at suitable times.

### SUMMARY

The present disclosure described herein provides an image forming apparatus including: a rotating member; a pressure roller pressed against the rotating member to form a nip between the rotating member and the pressure roller to convey a medium in a conveyance direction; a heater in the rotating member to heat the rotating member; a temperature sensor disposed, in a width direction orthogonal to the conveyance direction, outside a passing region through which a medium having a smallest usable width in the image forming apparatus passes; circuitry configured to: store width groups of media defined by a width of the medium in the width direction; determine the width groups to which the width of the medium passing through the nip belongs; count a number of media passing through the nip in each of the width groups; or measure a passing distance of media passing through the nip in the conveyance direction in each of the width groups; and set a service life of the pressure roller based on: a temperature detected by the temperature sensor; and one of: the number of media counted; or the passing distance measured.

The present disclosure described herein also provides an image forming apparatus including: an image forming device to form an image on a medium to perform an image forming operation at an image forming rate, a rotating member; a pressure roller pressed against the rotating member to form a nip between the rotating member and the pressure roller to convey a medium in a conveyance direction; a heater in the rotating member to heat the rotating member; a temperature sensor; circuitry configured to: determine whether a frequency of the image forming operation is larger than a predetermined threshold; limit the image forming rate in response to a determination that the frequency is larger than the predetermined threshold; accumulate one of: a number of times the circuitry limits the image formation rate; and a duration for which the circuitry limits the image formation rate; and determine whether a service life of the pressure roller has ended based on: a temperature detected by the temperature sensor; and one of the number of times and the duration.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a cross-sectional side view of a fixing device;

FIG. 3A is a perspective view of a retracted shield and a peripheral part of the shield;

FIG. 3B is a cross-sectional side view of the retracted shield and the peripheral part of the shield in FIG. 3A;

FIG. 4A is a perspective view of the shield enlarging a shield area and a peripheral part of the shield;

FIG. 4B is a cross-sectional side view of the shield enlarging the shield area and the peripheral part of the shield in FIG. 4A;

FIG. 5 is a diagram illustrating shield areas in the shield;

FIG. 6 is an exploded perspective view of a nip formation pad;

FIG. 7A is a diagram illustrating an arrangement of components such as halogen heaters in a longitudinal direction to describe temperature increases when small sheets pass through a fixing device;

FIG. 7B is a graph illustrating temperature distributions in the longitudinal direction of a pressure roller to describe the temperature increases when small sheets pass through the fixing device;

FIG. 8 is a graph illustrating a temperature distribution of the pressure roller in the longitudinal direction of the pressure roller and an outer diameter distribution of the pressure roller before heat deforms the pressure roller;

FIG. 9 is a graph illustrating a temperature distribution of the pressure roller in the longitudinal direction of the pressure roller and an outer diameter distribution of the pressure roller after heat deforms the pressure roller;

FIG. 10 is a graph illustrating deformation amounts of the pressure roller increasing as the counted number of sheets passing through a fixing nip increases under different detected temperatures;

FIG. 11 is a flow chart illustrating steps to determine the end of the life of a pressure roller;

FIG. 12 is a schematic diagram illustrating a pressure roller separated from a fixing belt and approaching the fixing belt;

FIG. 13 is a flow chart illustrating steps to notify the end of the life of a pressure roller;

FIG. 14 is a functional block diagram illustrating a configuration of an image forming apparatus to determine the end of the life of the pressure roller;

FIG. 15 is a functional block diagram illustrating a configuration of an image forming apparatus different from the configuration in FIG. 14 to determine the end of the life of the pressure roller;

FIG. 16 is a cross-sectional side view of an example of a fixing device including one halogen heater;

FIG. 17 is a cross-sectional side view of an example of a fixing device including three halogen heaters; and

FIG. 18 is a cross-sectional side view of another example of a fixing device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described in detail below with reference to the drawings. Like reference signs are assigned to like elements or components and descriptions of those elements or components may be simplified or omitted. The following describes a fixing device incorporated in an image forming apparatus as a heating device.

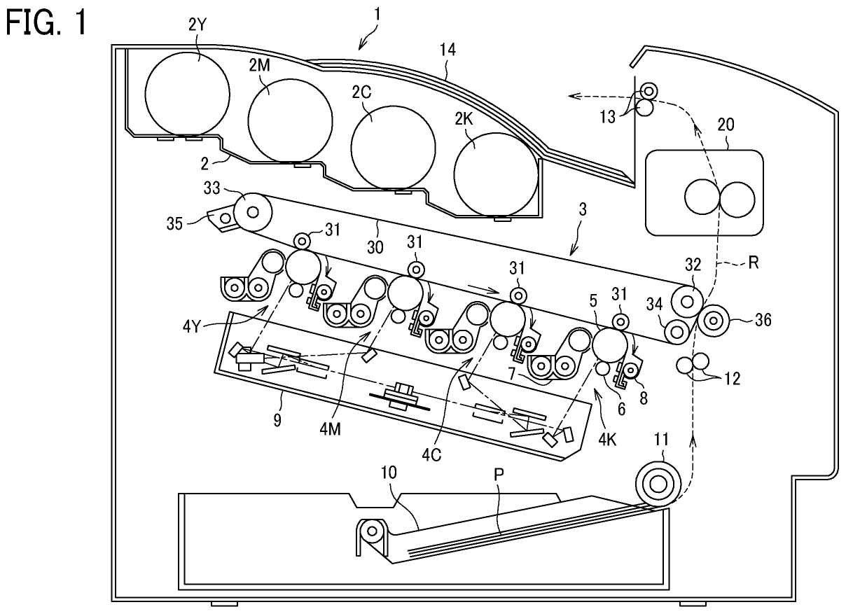

Initially, with reference to FIG. 1, a description is given of an overall configuration and operation of the image forming apparatus.

As illustrated in FIG. 1, an image forming apparatus 1 includes four image forming devices 4Y, 4M, 4C, and 4K disposed at a center portion of the image forming apparatus 1. The image forming devices 4Y, 4M, 4C, and 4K have substantially the same configuration except for containing different color developers (e.g., toners) of yellow (Y), magenta (M), cyan (C), and black (K), respectively, corresponding to color separation components of color images.

For example, each of the image forming devices 4Y, 4M, 4C, and 4K includes a drum-shaped photoconductor 5 as a latent image bearer, a charger 6 that charges an outer circumferential surface of the photoconductor 5; a developing device 7 that supplies toner to the outer circumferential surface of the photoconductor 5, and a cleaner 8 that cleans the outer circumferential surface of the photoconductor 5. FIG. 1 illustrates reference numerals assigned to the photoconductor 5, the charger 6, the developing device 7, and the cleaner 8 of the image forming device 4K that forms a black toner image. However, reference numerals for the image forming devices 4Y, 4C, and 4M that form yellow, cyan, and magenta toner images, respectively, are omitted for convenience.

An exposure device 9 is disposed below the image forming devices 4Y, 4M, 4C, and 4K and exposes the outer circumferential surfaces of the respective photoconductors 5 with laser beams. The exposure device 9 includes a light source, a polygon mirror, an f-θ lens, and reflection mirrors to irradiate the surfaces of the photoconductors 5 with laser beams according to image data.

A transfer device 3 is disposed above the image forming devices 4Y, 4M, 4C, and 4K. The transfer device 3 includes an intermediate transfer belt 30 as an intermediate transferor, four primary transfer rollers 31 as primary transferors, a secondary transfer backup roller 32, a secondary transfer roller 36 as a secondary transferor, a cleaning backup roller 33, a tension roller 34, and a belt cleaner 35.

The intermediate transfer belt 30 is an endless belt stretched taut across the secondary transfer backup roller 32, the cleaning backup roller 33, and the tension roller 34.

As a driver drives and rotates the secondary transfer backup roller 32 in a counterclockwise direction, the intermediate transfer belt 30 rotates in a direction indicated by an arrow in FIG. 1.

The four primary transfer rollers 31 sandwich the intermediate transfer belt 30 together with the four photoconductors 5, forming four primary transfer nips between the intermediate transfer belt 30 and the photoconductors 5, respectively. Each primary transfer roller 31 is connected to a power supply that applies a predetermined direct current (DC) voltage and/or alternating current (AC) voltage to each primary transfer roller 31.

The intermediate transfer belt 30 is interposed between the secondary transfer roller 36 and the secondary transfer backup roller 32 to form a secondary transfer nip. Similar to the primary transfer rollers 31, the secondary transfer roller 36 is connected to a power supply that applies a predetermined direct current (DC) voltage and/or alternating current (AC) voltage to the secondary transfer roller 36.

The belt cleaner 35 includes a cleaning brush and a cleaning blade that contact an outer circumferential surface of the intermediate transfer belt 30. A waste toner conveyance tube extends from the belt cleaner 35 to an inlet of a waste toner container and is connected to the inlet of the waste toner container.

The image forming apparatus 1 includes a bottle holder 2 in an upper portion of the image forming apparatus 1. The bottle holder 2 accommodates four toner bottles 2Y, 2M, 2C, and 2K detachably attached to the bottle holder 2. The toner bottles 2Y, 2M, 2C, and 2K contain fresh yellow, magenta, cyan, and black toners to be supplied to the developing devices 7 of the image forming devices 4Y, 4M, 4C, and 4K, respectively. The fresh yellow, magenta, cyan, and black toners are supplied from the toner bottles 2Y, 2M, 2C, and 2K to the developing devices 7 through toner supply tubes interposed between the toner bottles 2Y, 2M, 2C, and 2K and the developing devices 7, respectively.

In a lower portion of the body of the image forming apparatus 1, a sheet feeding tray 10 and a sheet feeding roller 11 are disposed. The sheet feeding tray 10 contains sheets P as recording media. The sheet feeding roller 11 feeds the sheet P as a recording medium from the sheet feeding tray 10. Examples of the recording medium include, but are not limited to, plain paper, thick paper, thin paper, coated paper such as art paper, tracing paper, overhead projector (OHP) transparency, a postcard, and an envelope. Additionally, the image forming apparatus 1 may include a bypass feeder.

The body of the image forming apparatus 1 includes a conveyance path R to eject the sheet P from the sheet feeding tray 10 to an outside of the image forming apparatus 1 via the secondary transfer nip. In the conveyance path R, a registration roller pair 12 as a pair of timing rollers is disposed upstream from the secondary transfer roller 36 in a direction in which the sheet P is conveyed (which is referred to as a sheet conveyance direction below). The registration roller pair 12 feeds the sheet P toward the secondary transfer nip at an appropriate time.

The image forming apparatus 1 includes a fixing device 20 disposed downstream from the secondary transfer roller 36 in the sheet conveyance direction. The fixing device 20 receives the sheet P bearing a toner image and fixes the toner image onto the sheet P. Additionally, the image forming apparatus 1 includes a sheet ejection roller pair 13 disposed on the conveyance path R downstream from the fixing device in the sheet conveyance direction to eject the sheet P to the outside of the image forming apparatus 1. The image forming apparatus 1 further includes an output tray 14 that is an upper face of the body of the image forming apparatus 1 to stock the sheet P ejected by the sheet ejection roller pair 13.

With reference to FIG. 1, a basic operation of the image forming apparatus 1 is described below.

When an image forming operation is started, a driver drives and rotates the photoconductor 5 in each of the image forming devices 4Y, 4M, 4C, and 4K clockwise in FIG. 1, and the charger 6 uniformly charges the surface of the photoconductor 5 in a predetermined polarity. The exposure device 9 emits laser beams onto the charged surfaces of the photoconductors 5, respectively, thus forming electrostatic latent images on the surfaces of the photoconductors 5. The image data used to expose the respective photoconductors 5 is monochrome image data produced by decomposing a desired full-color image into yellow, cyan, magenta, and black image data. The developing devices 7 supply yellow, magenta, cyan, and black toners to the electrostatic latent images formed on the photoconductors 5, visualizing the electrostatic latent images as yellow, magenta, cyan, and black toner images, respectively.

Simultaneously, as the image forming operation is started, the secondary transfer backup roller 32 is driven and rotated counterclockwise in FIG. 1, rotating the intermediate transfer belt 30 in the direction indicated by the arrow in FIG. 1 by friction therebetween. The power supply applies a constant voltage or a constant current control voltage having a polarity opposite a polarity of the charged toner to the primary transfer rollers 31, creating transfer electric fields at the respective primary transfer nips formed between the photoconductors 5 and the primary transfer rollers 31.

When the yellow, magenta, cyan, and black toner images formed on the photoconductors 5 reach the primary transfer nips, respectively, in accordance with rotation of the photoconductors 5, the transfer electric fields generated at the primary transfer nips transfer the yellow, magenta, cyan, and black toner images from the photoconductors 5 onto the intermediate transfer belt 30, respectively, such that the yellow, magenta, cyan, and black toner images are superimposed successively on the intermediate transfer belt 30. Thus, a full color toner image is formed on the surface of the intermediate transfer belt 30. After the primary transfer of the yellow, magenta, cyan, and black toner images from the photoconductors 5 onto the intermediate transfer belt 30, residual toner that is failed to be transferred onto the intermediate transfer belt 30 remains on each of the photoconductors 5. The cleaner 8 removes the residual toner from the photoconductor 5. Subsequently, a discharger removes the charge on the surface of the photoconductor 5 to initialize the surface potential of the photoconductor 5.

On the other hand, the sheet feeding roller 11 disposed in the lower portion of the image forming apparatus 1 is driven and rotated to feed the sheet P from the sheet feeding tray 10 to the conveyance path R. The registration roller pair 12 temporarily halts the sheet P fed to the conveyance path R.

Subsequently, the registration roller pair 12 is rotated at a predetermined time to convey the sheet P to the secondary transfer nip in synchronization with the full-color toner image formed on the intermediate transfer belt 30 reaching the secondary transfer nip. The power supply applies a transfer voltage to the secondary transfer roller 36. The transfer voltage has the polarity opposite the polarity of the charged toner contained in the full-color toner image formed on the intermediate transfer belt 30. As a result, a transfer electric field is generated at the secondary transfer nip. The transfer electrical field transfers the full-color toner image from the intermediate transfer belt 30 onto the sheet P at a time. After the secondary transfer of the full color toner image from the intermediate transfer belt 30 onto the sheet P, residual toner that is failed to be transferred onto the sheet P remains on the intermediate transfer belt 30. The belt cleaner 35 removes the residual toner from the intermediate transfer belt 30. The removed toner is conveyed and collected into the waste toner container.

Subsequently, the sheet P bearing the full color toner image is conveyed to the fixing device 20, and the fixing device 20 fixes the full color toner image onto the sheet P. The sheet P bearing the fixed full-color toner image is ejected by the sheet ejection roller pair 13 onto the outside of the image forming apparatus 1 and is stacked on the output tray 14.

The above describes the image forming operation of the image forming apparatus 1 to form the full-color toner image on the sheet P. Alternatively, the image forming apparatus 1 may form a monochrome toner image by using any one of the four image forming devices 4Y, 4C, 4M, and 4K or may form a bicolor toner image or a tricolor toner image by using two or three of the image forming devices 4Y, 4C, 4M, and 4K.

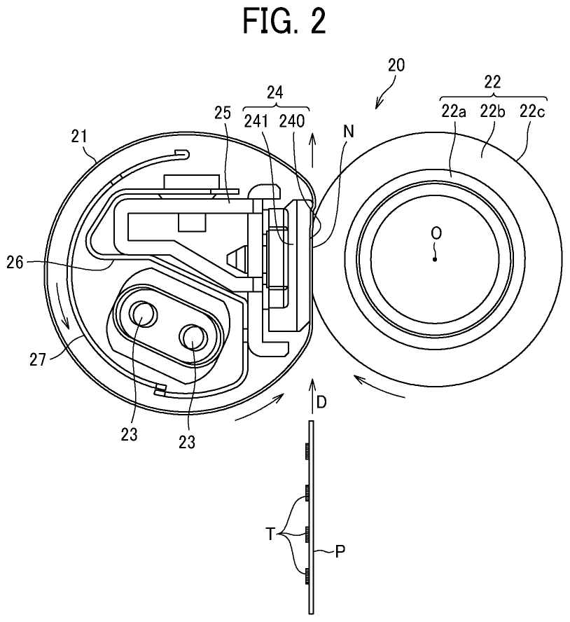

FIG. 2 is a cross-sectional side view of the fixing device 20. With reference to FIG. 2, the structure of the fixing device 20 is described below.

As illustrated in FIG. 2, the fixing device 20 includes a fixing belt 21, a pressure roller 22 as an opposed roller, halogen heaters 23 as heaters, a nip formation pad 24, a stay 25 as a support, a reflector 26, and a shield 27. The pressure roller 22 contacts and presses the outer circumferential surface of the fixing belt 21. The nip formation pad 24 contacts the inner circumferential surface of the fixing belt 21 and forms a fixing nip N between the fixing belt 21 and the pressure roller 22. The stay 25 supports the nip formation pad 24. The reflector 26 reflects heat radiated from the halogen heater 23 to the fixing belt 21. The shield 27 shields the fixing belt 21 from the heat radiated from the halogen heater 23. A fixing roller disposed in the fixing device is an aspect of a roller. The fixing belt 21 is an example of a rotating member.

The halogen heater 23 heats the fixing belt 21. The heated fixing belt 21 heats the pressure roller 22 at the fixing nip N. In other words, the halogen heater 23 indirectly heats the pressure roller 22. As described above, heating by the halogen heater 23 as the heater includes indirect heating via another component.

A direction perpendicular to a surface of the paper on which FIG. 2 is drawn (a direction indicated by a double-headed arrow X in FIG. 6) is a longitudinal direction of the fixing belt 21 and an axial direction of the pressure roller 22. This direction is referred to simply as the longitudinal direction. The halogen heaters 23, the nip formation pad 24, the stay 25, the reflector 26, and the shield 27 extend in the longitudinal direction. A direction indicated by an arrow D in FIG. 2 is the sheet conveyance direction.

The fixing belt 21 is a thin, flexible, endless belt (which may be a film). The fixing belt 21 is constructed of a base layer to form the inner circumferential surface of the fixing belt 21 and a release layer to form the outer circumferential surface of the fixing belt 21. The base layer is made of metal such as nickel or stainless steel (Stainless Used Steel, SUS). Alternatively, the base layer may be made of resin such as polyimide (PI). The release layer is made of tetrafluoroethylene-perfluoroalkylvinylether copolymer (PFA) or polytetrafluoroethylene (PTFE). Optionally, an elastic layer made of rubber such as silicone rubber, silicone rubber foam, or fluoro rubber may be interposed between the base layer and the release layer.

The fixing belt 21 not including the elastic layer has a small thermal capacity that enhances a fixing property. However, as the pressure roller 22 and the fixing belt 21 sandwich and press the unfixed toner image T on the sheet P passing through the fixing nip N, slight surface asperities of the fixing belt 21 may be transferred onto the toner image T on the sheet P, resulting uneven gloss of the solid toner image T. To address this circumstance, preferably, the fixing belt 21 includes the elastic layer not thinner than 100 μm. The elastic layer not thinner than 100 μm elastically deforms to absorb the slight surface asperities in the fixing belt 21, thus preventing uneven gloss of the toner image on the sheet P.

In order to decrease the thermal capacity of the fixing belt 21, the fixing belt 21 in the present embodiment is thin and has a decreased loop diameter. For example, the base layer of the fixing belt 21 is designed to have a thickness of from 20 μm to 50 μm, the elastic layer is designed to have a thickness of from 100 μm to 300 μm, and the release layer is designed to have a thickness of from 10 μm to 50 μm. Thus, the fixing belt 21 is designed to have a total thickness not greater than 1 mm. The loop diameter of the fixing belt 21 is set in a range of from 20 mm to 40 mm. In order to further decrease the thermal capacity of the fixing belt 21, preferably, the fixing belt 21 may have a total thickness not greater than 0.20 mm and more preferably not greater than 0.16 mm. Preferably, the loop diameter of the fixing belt 21 may be 30 mm or less.

The pressure roller 22 includes a core 22a, an elastic layer 22b disposed on the surface of the core 22a, and a release layer 22c disposed on the surface of the elastic layer 22b. The elastic layer 22b is made of foamed silicone rubber, silicon rubber, or fluoro-rubber. The release layer 22c is made of PFA or PTFE. A pressurization assembly presses the pressure roller 22 against the nip formation pad 24 via the fixing belt 21. At a portion at which the pressure roller 22 is pressed against the fixing belt 21, deformation of the elastic layer 22b of the pressure roller 22 forms the fixing nip N having a predetermined width in the sheet conveyance direction. The present disclosure is not limited to the fixing roller and the opposed roller that are pressed against each other. Alternatively, the fixing roller may merely contact the opposed roller with no pressure between them.

Decreasing the thicknesses of the elastic layer 22b and the release layer 22c enhances the heat-transfer performance of the pressure roller 22 and prevents a temperature of a part of the pressure roller 22 from rising. In contrast, increasing the thicknesses of the elastic layer 22b and the release layer 22c enhances the abrasion resistance in each of the elastic layer 22b and the release layer 22c and additionally causes heat to be unlikely transfer from the fixing belt 21 to the pressure roller 22. As a result, the halogen heater 23 can effectively heat the fixing belt 21.

A driver such as a motor disposed inside the body of the image forming apparatus 1 drives and rotates the pressure roller 22. As the driver drives and rotates the pressure roller 22, a driving force of the driver is transmitted from the pressure roller 22 to the fixing belt 21 at the fixing nip N, thus rotating the fixing belt 21 in accordance with rotation of the pressure roller 22 by friction between the fixing belt 21 and the pressure roller 22.

In the present embodiment, the pressure roller 22 is a solid roller. Alternatively, the pressure roller 22 may be a hollow roller. In this case, a heater such as a halogen heater may be disposed inside the hollow roller. The elastic layer 22b of the pressure roller 22 may be made of solid rubber. Alternatively, if no heater is disposed inside the pressure roller 22, the elastic layer of the pressure roller 22 may be made of sponge rubber. The sponge rubber is preferable to the solid rubber because the sponge rubber has enhanced thermal insulation that draws less heat from the fixing belt 21.

As illustrated in FIG. 2, the fixing device 20 includes the two halogen heaters 23. Alternatively, instead of the halogen heater 23, a resistive heat generator or a carbon heater may be used as a heater that heats the fixing belt 21.

The nip formation pad 24 includes a thermal equalizer 241 serving as a primary heat transfer device and a slide sheet 240 disposed on the surface of the thermal equalizer 241, the surface facing the fixing belt 21. The slide sheet 241 has a low coefficient of friction.

The thermal equalizer 241 is arranged so as to extend in the axial direction of the fixing belt 21 or the pressure roller 22. The thermal equalizer 241 receives a pressing force from the pressure roller 22 and determines a shape of the fixing nip N. In the present embodiment, the shape of the fixing nip N is a flat shape but may be a concave shape or another shape. The slide sheet 240 is disposed to reduce sliding friction when the fixing belt 21 rotates. If the thermal equalizer 241 is made of a low-friction material, the slide sheet 240 may not be interposed between the fixing belt 21 and the thermal equalizer 241.

The thermal equalizer 241 is made of a heat-resistant material having a heat-resistant temperature of 200 °C or more to prevent deformation of the nip formation pad 24 due to heat in the toner fixing temperature range, thereby ensuring a stable state of the fixing nip N and stabilizing qualities in the image on the ejected sheet P. The material of the thermal equalizer 241 may be typical heat-resistant resin such as polyethersulfone (PES), polyphenylene sulfide (PPS), liquid crystal polymer (LCP), polyethernitrile (PEN), polyamide-imide (PAI), and polyetheretherketone (PEEK).

The stay 25 supports and fixes the thermal equalizer 241. The stay 25 prevents the nip formation pad 24 from being bent by the pressure from the pressure roller 22 to form the fixing nip having a uniform width along the axial direction of the pressure roller 22. Preferably, the stay 25 is made of metal having an increased mechanical strength, such as stainless steel or iron, to prevent bending of the nip formation pad 24. The thermal equalizer 241 is preferably made of a rigid material to enhance the strength of the thermal equalizer 241. The material of the thermal equalizer 241 may be resin such as liquid crystal polymer (LCP), metal, or ceramic.

The reflector 26 is fixed and supported by the stay 25 so as to face the halogen heaters 23. The reflector 26 reflects heat or light radiated from the halogen heaters 23 toward the fixing belt 21 to reduce heat transferred to the stay 25, effectively heating the fixing belt 21 and saving energy. The material of the reflector 26 may be aluminum or stainless steel. In particular, the reflector made of an aluminum base on which silver having low emissivity (in other words, high reflectivity) is evaporated enhances the heating efficiency of the fixing belt 21.

The shield 27 is made of a metal plate having a thickness of 0.1 mm to 1.0 mm so as to have an arc-shaped cross-sectional shape along the inner peripheral surface of the fixing belt 21. The shield 27 is preferably made of ceramic or metal such as aluminum, iron, or SUS because the shield 27 requires heat resistance. The shield 27 is movable in a circumferential direction of the fixing belt 21.

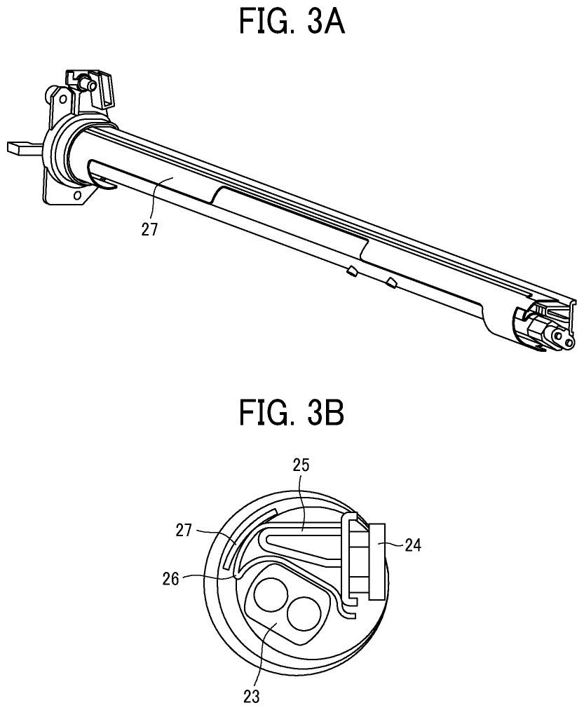

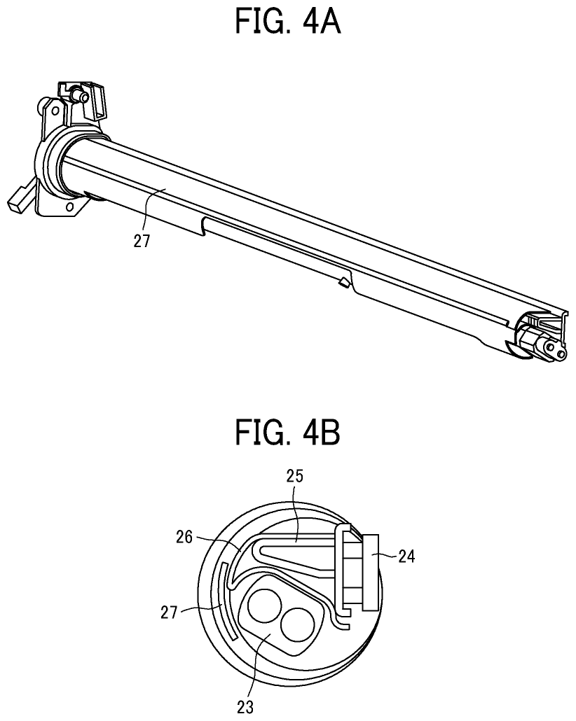

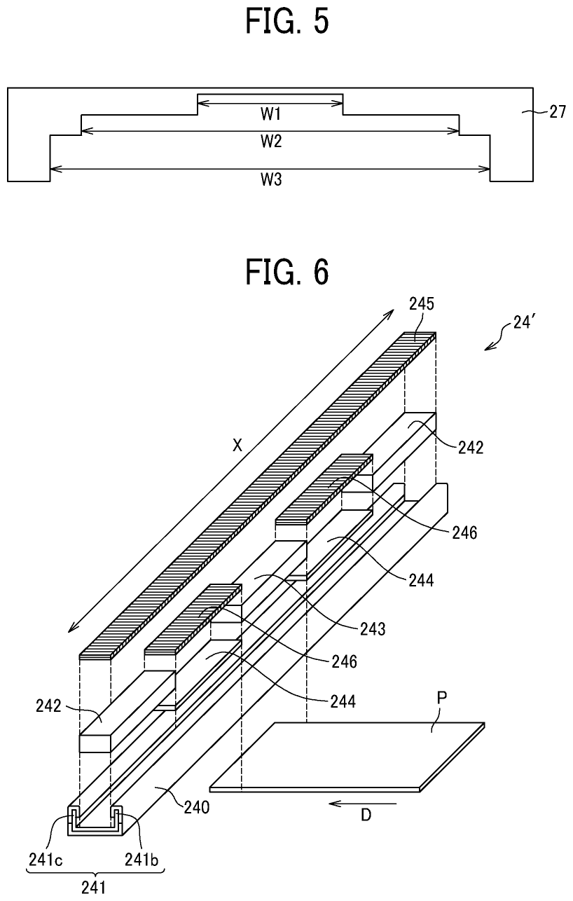

With reference to FIGS. 3A to 5, the shield 27 is described below. FIGS. 3A and 3B illustrate the shield 27 retracted to widen an area in which the halogen heaters 23 directly heat the fixing belt 21. In FIGS. 4A and 4B, the shield 27 shields heat radiated from the halogen heaters 23 to the fixing belt 21 and narrow the area in which the halogen heaters 23 directly heat the fixing belt 21. FIGS. 3A and 4A are perspective views of the shield 27 and a peripheral part of the shield 27. FIGS. 3B and 4B are cross-sectional side views of the shield 27 and the peripheral part of the shield 27. FIG. 5 is a diagram illustrating shield areas in the shield 27.

As illustrated in FIG. 5, the shield 27 has multiple steps forming light-shielding areas corresponding to the widths of the recording media (sheet widths). In an example illustrated in FIG. 5, W1 corresponds to a post card, W2 corresponds to the recording medium having B4 size, and W3 corresponds to the recording medium having A3 size. The B4 size and A3 size are defined by Japanese Industrial Standards (JIS). As illustrated in FIGS. 3A to 4B, the shield 27 is arranged so as to rotate to a position corresponding to each sheet width along the inner circumferential surface of the fixing belt 21 not to be in contact with the fixing belt 21, and the shield 27 shields light that is radiated to an area unnecessary for heating the sheet. For example, FIGS. 3A and 3B illustrate a case in which the sheet having the A3 size passes through the fixing device 20, and FIGS. 4A and 4B illustrate a case in which the post card passes through the fixing device 20. Since the shield 27 shields radiant heat that is radiated to the area unnecessary for heating the sheet, an excessive temperature increase in a non-sheet-passing region does not occur even when sheets each having a small width continuously pass through the fixing device 20. As a result, a controller (circuitry) of the image forming apparatus 1 does not need to perform control, such as reducing productivity, to eliminate a region of excessive temperature increase.

FIG. 6 is an exploded perspective view of a nip formation pad 24′ having a structure different from the above-described nip formation pad 24. With reference to FIG. 6, the structure of the nip formation pad 24′ is described below. The structure illustrated in FIG. 6 aims to reduce the excessive temperature increase in the non-sheet-passing region, and has a function of reducing the number of halogen heaters and a function of substituting for the shield 27. As a result, the structure illustrated in FIG. 6 can remove the shield 27 and the driver that drives the shield 27, allowing significant cost reduction.

As illustrated in FIG. 6, the nip formation pad 24′ includes first heat insulators 242 and 243, second heat insulators 244, a first heat absorber 245, and second heat absorbers 246 in addition to the thermal equalizer 241 and the slide sheet 240. A part of the nip formation pad 24′ is formed by layering the slide sheet 240, the thermal equalizer 241, the first heat insulator 242 or 243, and the first heat absorber 245 in the lateral direction of FIG. 2. The other part of the nip formation pad 24′ is formed by layering the slide sheet 240, the thermal equalizer 241, the second heat insulator 244, the second heat absorber 246, and the first heat absorber 245 in the lateral direction of FIG. 2.

The thermal equalizer 241 may be made of metal having a high thermal conductivity, for example, copper.

The thermal equalizer 241 is formed to extend in the longitudinal direction of the fixing belt 21 (see FIG. 2), absorbs excessive heat stored in the non-sheet-passing region on the fixing belt 21, and conducts the absorbed heat in the longitudinal direction of the thermal equalizer 241. The thermal equalizer 241 includes bent portions 241b and 241c. The bent portion 241b disposed upstream from the fixing nip in the sheet conveyance direction has a sharp edge. While the fixing belt 21 rotates, the fixing belt 21 pulls the slide sheet 240 in a direction in which the fixing belt 21 slides on the slide sheet. However, the sharp edge of the bent portion 241b catches or engages the slide sheet 240, holding the slide sheet 240 to the nip formation pad 24′ solidly. If the fixing belt 21 is configured to rotate in a reverse direction opposite the above-described rotation direction, forming the sharp edge on the bent portion 241c gives the same advantage.

The first heat insulators 242 are disposed at both end portions of the thermal equalizer 241 in the longitudinal direction of the thermal equalizer 241. The first heat insulator 243 is disposed at a center portion of the thermal equalizer 241 in the longitudinal direction of the thermal equalizer 241. The first heat insulators 242 and 243 are made of a material having a thermal conductivity smaller than a thermal conductivity of the thermal equalizer 241, for example, resin, thus preventing the first heat absorber 245 from absorbing heat from the fixing belt 21 excessively. As a result, the above-described structure prevents the temperature in a sheet-passing region of the fixing belt 21 where the sheet is conveyed over the fixing belt 21 from falling, preventing the occurrence of faulty fixing, shortening a warm-up time taken to warm up the fixing belt 21, and reducing energy consumption. Similarly, the second heat insulator 244 is made of resin, for example. The second heat insulator 244 adjusts an amount of heat conducted from the thermal equalizer 241 to the first heat absorber 245 through the second heat absorber 246. The thickness and the width of the second heat insulator 244 are adjusted based on the degree of overheating or temperature increase in the non-sheet-passing region of the fixing belt 21. Each of the first heat absorber 245 and the second heat absorber 246 is made of a material having a high thermal conductivity. The second heat absorber 246 is disposed so as to face a position at which the temperature increase in the non-sheet-passing region of the fixing belt 21 occurs. Like the second heat insulator 244, the thickness and the width of the second heat absorber 246 are adjusted based on the degree of overheating or temperature increase in the non-sheet-passing region of the fixing belt 21.

The following describes a problem due to a thermal deformation of the pressure roller caused by the temperature increase when small sheets pass through the fixing device.

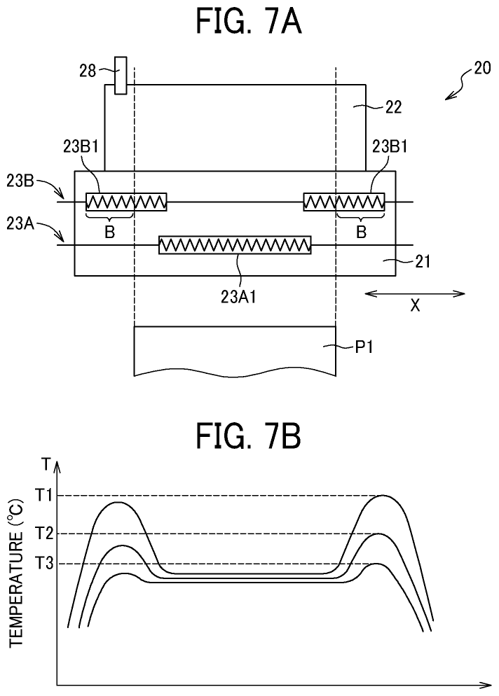

With reference to FIGS. 7A and 7B, the temperature increase when small sheets pass through the fixing device is described below. FIG. 7A is a diagram illustrating an arrangement of components such as halogen heaters in the longitudinal direction. FIG. 7B is a graph illustrating temperature distributions in the longitudinal direction of the pressure roller.

As illustrated in FIG. 7A, the fixing device 20 according to the present embodiment includes a central heater 23A and an end heater 23B. In FIGS. 2 to 4B, the central heater 23A and the end heater 23B are together expressed as the halogen heaters 23. The central heater 23A has a main heat generation region 23A1 disposed at the center portion of the central heater 23A in the longitudinal direction. The end heater 23B has main heat generation regions 23B1 disposed at both end portions of the end heater 23B in the longitudinal direction. As a result, the central heater 23A and the end heater 23B have main heat generation regions 23A1 and 23B1 differently arranged in the longitudinal direction. A filament in each of the main heat generation regions 23A1 and 23B1 is coiled more densely than the filament in a part other than the main heat generation regions 23A1 and 23B1 to generate a larger heat generation amount per a unit length in each of the main heat generation regions 23A1 and 23B1 than that in the part other than the main heat generation regions 23A1 and 23B1.

The fixing device 20 includes a temperature sensor 28. The temperature sensor 28 contacts the surface of an end portion of the pressure roller 22 to detect the temperature of the end portion of the pressure roller 22 in the longitudinal direction of the pressure roller 22. The temperature sensor 28 may have another structure such as a non-contact type temperature sensor. The center portion of the halogen heater (the heater) in the longitudinal direction may be, for example, the center portion of the halogen heater when the halogen heater is divided into three equal parts in the longitudinal direction. The center portion of the pressure roller (the pressure roller) in the longitudinal direction may be, for example, the center portion of the pressure roller when the pressure roller is divided into three equal parts in the longitudinal direction. Both end portions may be, for example, end portions when the halogen heater and the pressure roller are divided into three equal parts in the longitudinal direction.

The width of the sheet P1 passing through the fixing device 20 in FIG. 7A is smaller than the maximum width of sheets that can pass through the fixing device 20 and larger than the main heat generation region 23A1 of the central heater 23A. In this case, both the central heater 23A and the end heater 23B are energized to cause both the main heat generation regions 23A1 and 23B1 to generate heat. As a result, the central heater 23A and the end heater 23B heat the regions of fixing belt 21 and pressure roller 22 that face the entire sheet-passing region.

In this case, the range formed by the main heat generation regions 23A1 and 23B1 is larger than the sheet-passing region of sheet P1. Specifically, the range formed by the main heat generation regions 23A1 and 23B1 is larger than the sheet-passing region of sheet P1 by the length of regions B, as illustrated in FIG. 7A. In the region B, the sheet P1 does not absorb the heat of the fixing belt 21 and the pressure roller 22. As a result, temperatures of parts of the pressure roller 22 and the fixing belt 21 that correspond to the regions B rise to be larger than temperatures of other parts.

The temperature sensor 28 (in particular, a temperature sensing part such as a temperature sensing element) is disposed inside the region B in the longitudinal direction and detects the temperature of the part of the pressure roller 22 that corresponds to the region B. In other words, the position of the temperature sensor 28 in the longitudinal direction is inside the main heat generation regions 23A1 and 23B1 of the halogen heater 23 and inside the non-sheet-passing region of the sheet having any one of the sheet widths. In particular, the temperature sensor 28 in the present embodiment is disposed at a position at which the amount of temperature increase in the pressure roller 22 is large. In the present embodiment, the temperature sensor 28 is disposed outside a region through which the sheet having the smallest width in the sheets usable in the image forming apparatus 1 in a width direction. The width direction of the sheet (the recording medium) is defined as a direction orthogonal to the sheet conveyance direction and along the surface of the sheet. Specifically, the width direction is orthogonal to the sheet conveyance direction in the fixing nip and parallel to the surface of the sheet (the recording medium) passing through the fixing nip. In addition, the width direction is parallel to the longitudinal direction of the heater.

Since the size of sheet P1 in the width direction changes the above-described region B, that is, the region in which the temperature of the pressure roller 22 especially rises, the size of sheet P1 in the width direction changes the amount of temperature increase in the region B. In addition, other conditions change the temperature increase in the pressure roller 22 even if the sheets having the same width pass through the fixing device. For example, FIG. 7B illustrates three examples of temperature distributions in the pressure roller 22 under different conditions. The temperature distributions include different highest temperatures T1, T2, and T3 and different curves. As illustrated in FIG. 7B, the temperature distributions under different conditions are different. The above-described other conditions include a lighting rate of the heater and the number of sheets continuously passing through the fixing nip. The width of the sheet (that is, the width of the recording medium) is the length of the sheet in the direction orthogonal to the sheet conveyance direction and the direction along the surface of the sheet.

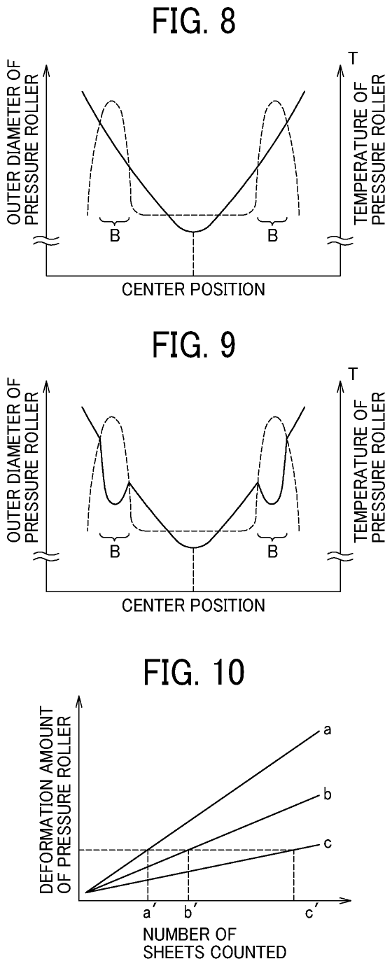

A change in the outer diameter of the pressure roller due to the temperature increase of the pressure roller is described with reference to FIGS. 8 and 9. In each of FIGS. 8 and 9, a horizontal axis represents the position of the pressure roller, a vertical axis at the left side represents the outer diameter of the pressure roller, and a vertical axis at the right side represents the temperature of the pressure roller. In each of FIGS. 8 and 9, the dotted line curve presents the temperature distribution of the pressure roller. The solid line curve in FIG. 8 presents the outer diameter distribution of the pressure roller before the pressure roller thermally deforms, and the solid line curve in FIG. 9 presents the outer diameter distribution of the pressure roller after the pressure roller thermally deforms.

As illustrated in FIG. 8, the pressure roller 22 has an hourglass shape in which the outer diameter of the pressure roller 22 increases from the center toward both ends in the longitudinal direction. In the above-described structure, a linear velocity of the surface of the pressure roller 22 increases from the center to both ends in the longitudinal direction when the pressure roller 22 rotates. This linear velocity distribution generates a force from the center to both ends in the longitudinal direction, and the force is applied to the sheet passing through the fixing nip, which prevents the occurrence of wrinkles in the sheet. In FIG. 7A, the pressure roller 22 is illustrated by a rectangular shape as a convenience.

Since the sheet does not absorb heat from the pressure roller 22 in the regions B of FIG. 8, the temperature of the pressure roller in the region B especially increases compared with temperatures in regions other than the region B. This temperature increase decreases the outer diameter of the pressure roller 22 in the region B as illustrated in FIG. 9. Specifically, the above-described temperature increase damages the rubber layer of the pressure roller 22 and causes the compression set of the rubber layer, reducing the outer diameter of the pressure roller 22. The above-described deformation of the pressure roller 22 distorts the linear velocity distribution of the surface of the pressure roller 22, which causes the wrinkles in the sheet.

To address this circumstance, the controller (that is, circuitry) in the image forming apparatus 1 according to the present embodiment counts the number of sheets passing through the fixing nip in each of items to determine whether the life of the pressure roller 22 is over. The items are defined by combinations of two factors. The two factors are the width of the sheet passing through the fixing device and the temperature detected by the temperature sensor 28 at that time. The examples of the above-described combinations are illustrated in Table 1 below.

TABLE 1

| | | DETECTED TEMPERATURE GROUP | | | |
|---|---|---|---|---|---|
| | | a ≤ T | b ≤ T < a | c ≤ T < b | d ≤ T < c |
| SHEET | 1 | 50 | 300 | 500 | 1000 |
| WIDTH | 2 | 0 | 200 | 300 | 500 |
| GROUP | 3 | 0 | 0 | 100 | 300 |
| | 4 | 0 | 0 | 0 | 200 |

In the present embodiment, the controller determines the end of the life of the pressure roller 22 based on the number of sheets passing through the fixing nip, which is referred to as a life determination number of sheets below. As illustrated in Table 1, the life determination number of sheets is determined in each of service-life groups that are the combinations defined by the detected temperature groups and the sheet width groups. The sheet width groups in the present embodiment are four groups defined by the widths of sheets (that are distances of the recording media in the width direction) and illustrated by 1 to 4 in Table 1. The detected temperature groups are four groups that are ranges of temperatures detected by the temperature sensor, the ranges defined by threshold values d, c, b, and a as illustrated in Table 1.

For example, the controller determines that the life determination number of sheets is 300 sheets when the detected temperature T is in the group defined by the detected temperature equal to or larger than c and smaller than d and the width of the sheet is in group 2 in Table 1. Table 1 includes combinations that do not occur. In each of the combinations that do not occur, zero is assigned as a temporary number. Regarding the ranges of detected temperatures, the threshold value a corresponds to the highest temperature, and the threshold value d corresponds to the lowest temperature. The detected temperature may be detected when the sheet passes through the fixing nip or may be the highest temperature detected during the image forming operation. Regarding the sheet width groups, group 1 includes the smallest sheet width, and group 4 includes the largest sheet width.

In Table 1, the larger the detected temperature is, the smaller the life determination number of sheets is. This is because the thermal deformation amount of the pressure roller increases in proportion to the detected temperature. In other words, as the detected temperature increases like c<b<a, the deformation amount of the pressure roller per sheet, that is, the slope of each straight line in FIG. 10, increases. Accordingly, the life determination number of sheets decreases like c′>b′>a′. In addition, the smaller the width of the sheet is, the larger the life determination number of sheets is. The reason is as follows. In the example in Table 1, the smaller the width of the sheet, the smaller the length of the sheet in the sheet conveyance direction. The smaller the length of the sheet in the sheet conveyance direction, the shorter the time the sheet passes through the fixing nip. The shorter the time the sheet passes through the fixing nip, the shorter the lighting time of the heater. As a result, the smaller the width of the sheet, the larger the life determination number of sheets. As described above, considering the length of the sheet in the sheet conveyance direction enables the determination of the life determination number of sheets. However, Table 1 is just an example. Reducing the width of the sheet does not necessarily reduce the length of the sheet in the sheet conveyance direction. The length of the sheet in the sheet conveyance direction is referred to as the distance of the sheet in the sheet conveyance direction in this specification. For example, when the sheet having A4 size passes through the fixing device so that the width of the sheet is 297 mm, the length of the sheet in the sheet conveyance direction is 210 mm. In contrast, when the sheet having A4 size passes through the fixing device so that the width of the sheet is 210 mm, the length of the sheet in the sheet conveyance direction is 297 mm. In this case, the larger the width of the sheet, the smaller the length of the sheet in the conveyance direction. Accordingly, the smaller the width of the sheet, the smaller the life determination number of sheets in this case.

Examples of the sheet width groups may be a range equal to or smaller than 105 mm, a range larger than 105 mm and equal to or smaller than 140 mm, a range larger than 140 mm and equal to or smaller than 170 mm, a range larger than 170 mm and equal to or smaller than 210 mm, a range larger than 210 mm and equal to or smaller than 225 mm, a range larger than 225 mm and equal to or smaller than 254 mm, a range larger than 254 mm and equal to or smaller than 270 mm, a range larger than 270 mm and equal to or smaller than 297 mm, a range larger than 297 mm and equal to or smaller than 300 mm, a range larger than 300 mm and equal to or smaller than 305 mm, a range larger than 305 mm and equal to or smaller than 324 mm, and a range larger than 324 mm. The sheet width groups do not need to include all of the above ranges and may be appropriately set based on the widths of sheets passing through the fixing device. The sheet width group may include multiple widths of sheets.

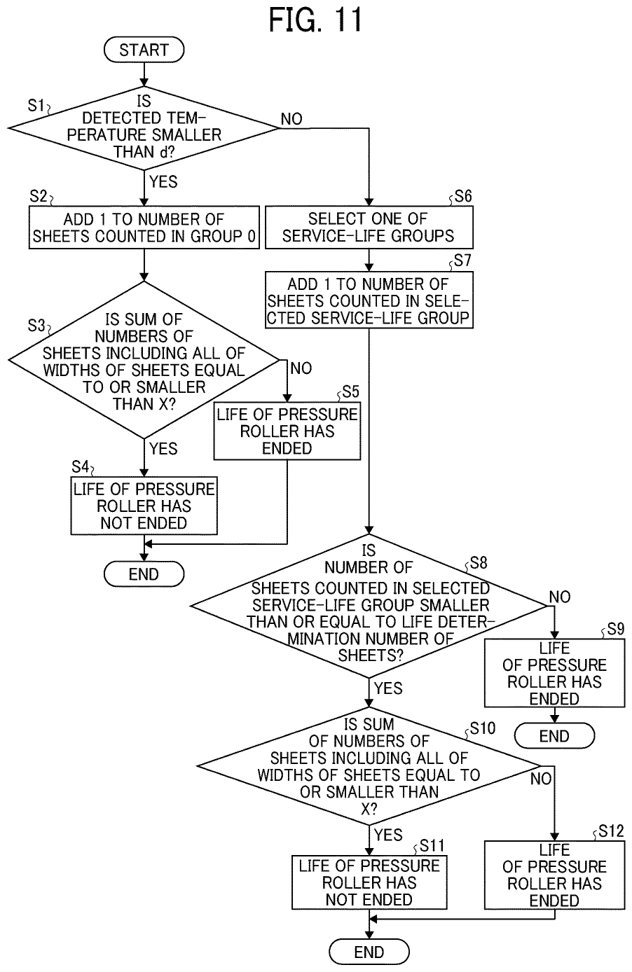

With reference to FIG. 11, the following describes a flow chart to determine the end of the life of the pressure roller.

As illustrated in FIG. 11, in step S1, the controller initially determines whether the temperature detected by the temperature sensor is smaller than d. If the controller determines that the detected temperature is smaller than d, the controller adds 1 to the number of sheets counted in group 0, regardless of the sheet width groups in Table 1 (step S2). If the detected temperature is smaller than d, the thermal deformation of the pressure roller affects the life of the pressure roller to a limited extent or does not shorten the life of the pressure roller. Therefore, the controller performs typical service-life determination processes. Specifically, in step S3, the controller determines whether the sum of the number of sheets including all of the widths of sheets is equal to or smaller than X. If the sum of the number of sheets is equal to or smaller than X, the controller determines that the life of the pressure roller has not ended (step S4). If the sum of the number of sheets is larger than X, the controller determines that the life of the pressure roller has ended (step S5).

On the other hand, if the controller determines that the detected temperature is d or more, the controller determines which detected temperature group the detected temperature belongs to and which sheet width group the sheet passing through the fixing nip belongs to, and selects one of the service-life groups in Table 1 based on the combination of the detected temperature group and the sheet width group (step S6). In step S7, the controller adds 1 to the number of sheets counted in the selected service-life group. In other words, the controller accumulates the number of sheets in the selected service-life group. In step S8, the controller determines whether the number of sheets to which 1 is added as described above is smaller than or equal to the life determination number of sheets in the selected service-life group. If the controller determines that the number of sheets to which 1 is added exceeds the life determination number of sheets in the selected service-life group, the controller determines that the life of the pressure roller has ended (step S9). If the controller determines that the number of sheets to which 1 is added is smaller than or equal to the life determination number of sheets in the selected service-life group, the controller determines whether the sum of the number of sheets including all of the widths of sheets is equal to or smaller than X in step S10, similar to the above-described step S3. If the sum of the number of sheets is equal to or smaller than X, the controller determines that the life of the pressure roller has not ended (step S11). If the sum of the number of sheets is larger than X, the controller determines that the life of the pressure roller has ended (step S12). When the life of the pressure roller has reached the end, the controller may limit a function of the image forming operation or may not limit the function. Additionally, the controller may control a notification device such as a display in an operation panel or a speaker to notify an operator that the life of the pressure roller has reached the end.

As described above, the controller in the image forming apparatus 1 according to the present embodiment determines the end of the life of the pressure roller using the combinations of the widths of the sheets passing through the fixing device and the temperatures detected by the temperature sensor. Accordingly, the controller can determine that the life of the pressure roller has reached the end when the thermal deformation caused by the temperature increase of the pressure roller increases, and the end of the life of the pressure roller can be appropriately determined. Basically, even if the sheets having the same width pass through the fixing device, other conditions change the temperature distribution in the pressure roller as illustrated in FIG. 7B. Conversely, even if the temperatures detected by the temperature sensor are the same, the width of the sheet passing through the fixing nip changes the non-sheet-passing region heated by the heater, and, as a result, changes the temperature distribution of the pressure roller. Accordingly, determining the end of the life of the pressure roller using both the widths of the sheets passing through the fixing device and the temperatures detected by the temperature sensor can more appropriately determine the end of the life of the pressure roller.

The fixing device according to the present embodiment includes two halogen heaters 23A and 23B (see FIG. 7A) having different main heat generation regions. This configuration can increase types of sheets having various widths of sheets usable in the fixing device. On the other hand, the width of the sheet changes the non-sheet-passing region and the region such as the region B as illustrated in FIG. 7A, the region that is the non-sheet-passing region and heated by the main heat generation region 23B1. Accordingly, the above-described configuration in the present embodiment suitably determines the end of the life of the pressure roller because the width of the sheet passing through the fixing device and a driving condition of the fixing device change the thermal deformation amount of the pressure roller.

The controller in the above embodiment independently determines the end of the life of the pressure roller in each of the detected temperature groups. However, the controller may add up the numbers of sheets counted in the detected temperature groups to determine the end of life of the pressure roller. Specifically, the controller may store a service-life value set in each of the sheet width groups and determine the end of the life of the pressure roller based on an accumulated weighted value obtained by accumulating the numbers of sheets weighted for each detected temperature group. For example, the controller may use the expression Fa× Ha+Fb× Hb+Fc× Hc to calculate the accumulated weighted value, where Ha, Hb, and Hc are the slopes of the straight lines with a, b, and c in the graph in FIG. 10, and Fa, Fb, and Fc are the numbers of sheets counted (or distances accumulated) in the detected temperature groups. The detected temperature groups correspond to a, b, and c. The controller determines whether the accumulated weighted value exceeds the service-life value to determine whether the life of the pressure roller has ended. The above-described values Ha, Hb, and Hc are weight coefficients of detected temperature groups. The above-described service-life value corresponds to a threshold value of the deformation amount of the pressure roller (and the value indicated by the horizontal dotted line in FIG. 10). The deformation amount of the pressure roller is estimated by the accumulated weighted value, and the accumulated weighted value is obtained by integrating values that are each obtained by multiplying the weight coefficient by the number of sheets passing through the fixing nip or the sum of distances of sheets in the sheet conveyance direction, the sheets passing through the fixing nip. The controller determines whether the estimated value (that is the accumulated weighted value) exceeds the service-life value to determine whether the life of the pressure roller has ended. The controller performs the above-described determination process for each sheet width group. As a result, the controller can more appropriately determine the end of the life of the pressure roller depending on the deformation amount of the pressure roller.

Compared with this embodiment, the embodiment illustrated in FIG. 11 has the advantage of reducing the complexity of control, that is, the increase in CPU load, and reducing the cost of the image forming device.

In the embodiment illustrated by FIG. 11, the controller counts the number of sheets in each of the sheet width groups. However, the controller may accumulate sheet distances in each of the sheet width groups. The sheet distance means a length of the sheet passing through the fixing nip N, the length in the sheet conveyance direction.

In this case, the controller stores a life determination distance in each of the service-life groups instead of the above-described life determination number of sheets.

In the above description, the controller determines the end of the life of the pressure roller based on the temperatures detected by the temperature sensor and the numbers of sheets passing through the fixing device in the sheet width groups, or based on the temperatures detected by the temperature sensor and accumulated sheet distances in the sheet width groups. In other words, the controller changes the life of the pressure roller based on the temperatures detected by the temperature sensor and the numbers of sheets passing through the fixing device in the sheet width groups, or based on the temperatures detected by the temperature sensor and accumulated sheet distances in the sheet width groups. Alternatively, the controller may determine the end of the life of the pressure roller based on the number of times the productivity-reducing control is performed or the duration for which the productivity-reducing control is performed.

The productivity-reducing control reduces an image formation rate of the image forming apparatus and reduces the productivity of the image forming apparatus when the frequency of image forming operations is large, for example, when the image forming apparatus continuously forms a large number of images. For example, the productivity-reducing control reduces the maximum image formation rate of 50 prints per minute (ppm) to 40 ppm. The controller may determine whether the controller performs the productivity-reducing control based on the temperature detected by the temperature sensor 28 (see FIG. 7). Performing the productivity-reducing control based on the detected temperature can reduce the temperature detected by the temperature sensor 28 below a certain level. The controller may also determine whether to perform the productivity-reducing control based on the number of sheets printed for a predetermined time or the time for which the sheets pass through the fixing device.

For example, reducing the productivity (in other words, the image formation rate) of the image forming apparatus from 100% to 80% and then 60% in stages controls the temperature inside the image forming apparatus, in particular, the temperature of the pressure roller in the fixing device to be below a predetermined temperature. If this predetermined temperature is included the detected temperature group corresponding to the slope Ha of the solid line “a” in FIG. 10, the controller calculates Ha x the number of times that the productivity-reducing control is performed (or the duration for which the productivity-reducing control is performed) and determines whether the calculated value exceeds a predetermined threshold set in advance to determine whether the life of the pressure roller has reached the end.

The above-described control according to the present embodiment can appropriately determine whether the life of the pressure roller reaches the end without adding a new electric part. Accordingly, the cost of the image forming apparatus is reduced. The determination based on the duration for which the productivity-reducing control is performed is preferable than the determination based on the number of times that the productivity-reducing control is performed. When the productivity is reduced in stages as described above, the number of times the productivity-reducing control is performed does not give information on how much the productivity is reduced. On the other hand, since the degree of productivity loss increases in proportion to the duration for which the productivity-reducing control is performed, the determination based on the duration for which the productivity-reducing control is performed can more appropriately determine whether the life of the pressure roller reaches the end in case of simple evaluation.

In the image forming apparatus with low productivity (that means the largest image formation rate is small), the temperature of the pressure roller does not excessively increase, and the deformation that causes the wrinkles in the sheet is unlikely occur. Accordingly, when the largest image formation rate does not exceed a predetermined threshold value, the controller may determine whether the life of the pressure roller reaches the end based on the number of sheets counted regardless of the widths of the sheets, for example, as illustrated by step S3 in FIG. 11, without performing the above-described service-life determination processes. In the image forming apparatus with the productivity that exceeds the predetermined threshold value, the controller may perform the above-described service-life determination processes. This prevents control load from unnecessarily increase and prevents the cost of the image forming apparatus from increasing.

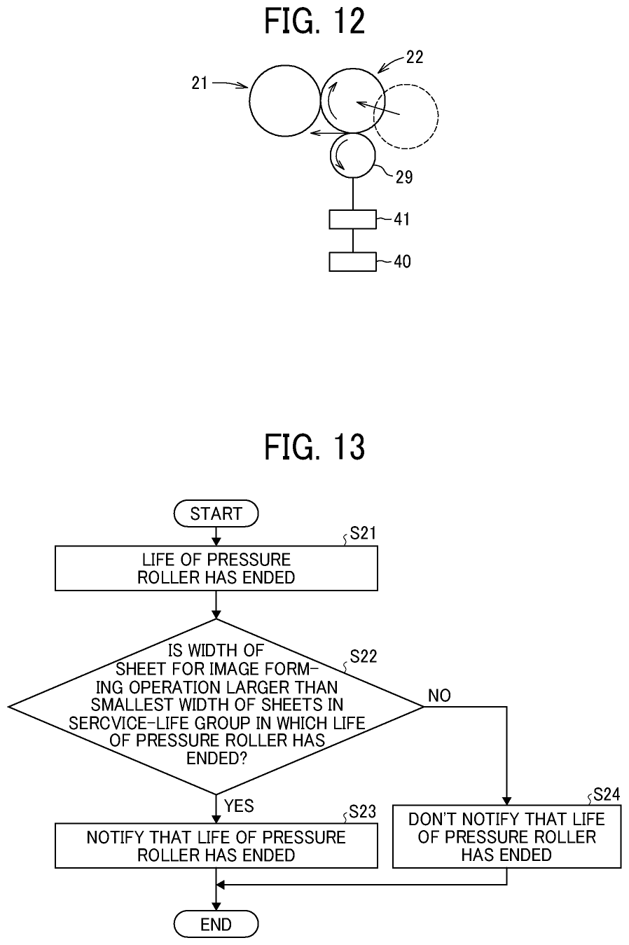

As illustrated in FIG. 12, the pressure roller 22 in the present embodiment can move from a position drawn by a solid line in FIG. 12, the position at which the pressure roller 22 is pressed against the fixing belt 21, to a pressure release position illustrated in FIG. 12, the pressure release position at which the pressure roller 22 is separated from the fixing belt 21.

The above-described configuration enhances the workability in jam processing, and releasing pressure applied from the pressure roller 22 to the fixing belt 21 during a non-image-forming operation can reduce the deformation of the pressure roller.

The image forming apparatus 1 includes a motor 40 as the driver and a driving force transmission 29, such as a gear or a roller. The motor generates a driving force to rotate the pressure roller 22, and the driving force transmission 29 transmits the driving force to rotate the pressure roller 22. The rotation of the pressure roller 22 rotates the fixing belt 21 by friction between the pressure roller 22 and the fixing belt 21. The fixing device 20 includes a torque measuring device 41 such as a torque meter. The torque measuring device 41 detects a torque to rotate the pressure roller 22. The torquemeters are commercially available, for example, from MinebeaMitsumi Inc.

The pressure roller 22 is moved toward the fixing belt 21 and pressed against the fixing belt 21. As a result, the pressure roller 22 is in pressure contact with the fixing belt 21. This state increases the torque to rotate the pressure roller 22. The pressure contact state in which the pressure roller 22 is pressed against the fixing belt 21 generates a pressing force that causes the deformation of the pressure roller 22. Accordingly, the controller may change the life of the pressure roller 22 based on the pressing force caused by the pressure roller 22 in addition to the above-described temperature increase in the pressure roller 22. Specifically, the life determination number of sheets illustrated in Table 1 is reduced based on an increase in the torque detected by the torque measuring device 41. For example, the controller obtains the detected torque and a time in which the detected torque is measured to calculate a value in which the detected torque is multiplied by the time, and based on the value, the controller reduces the life determination number of sheets. Alternatively, the controller may add the value in which the detected torque is multiplied by the time to the number of sheets counted or the sum of the distances of the sheets.

In the above-described flowchart in FIG. 11, the controller determines that the life of the pressure roller 22 has ended and controls the notification device to notify the operator that the life of the pressure roller 22 has ended in addition to the need to replace the pressure roller with a new one. The notification device may be, for example, the operation panel that displays the notification. Alternatively, the image forming apparatus may make an alert or an alarm.

It is not necessary to notify the operator that the life of the pressure roller 22 has ended immediately after the controller determines that the life of the pressure roller 22 has ended. As illustrated in FIG. 9, the pressure roller 22 is thermally deformed in regions B. The sheet with a width smaller than the distance between regions B is not affected by the thermal deformation of the pressure roller 22 and can normally pass through the fixing device. Therefore, even if the controller determines that the number of sheets counted in a certain sheet width group has reached the life determination number of sheets, the controller can allow the image forming operation to be performed on the sheet with a width smaller than or equal to the smallest width of the certain sheet width group. In addition, when the controller receives an instruction to form an image on a sheet with a width larger than the smallest width of the sheet width group in which the controller determines that the number of sheets has reached the life determination number of sheets, the controller can notify that the life of the pressure roller has ended. When the life of the pressure roller 22 has ended, the controller may limit a function of the image forming operation or may not limit the function.

With reference to a flowchart illustrated in FIG. 13, the following describes the procedure of the above-described notification.

As illustrated in FIG. 13, in step S21, the controller determines that the life of the pressure roller has ended after the steps of the flowchart in FIG. 11. In other words, the controller determines that the number of sheets counted in a certain service-life group is larger than the life determination number of sheets (in step S21). After receiving the instruction for the image forming operation, the controller determines whether the width of the sheet contained in the instruction to perform the image forming operation is larger than the smallest width of the sheets included in the above service-life group (in step S22). If the controller determines that the width of the sheet contained in the instruction is larger than the smallest width of the sheets included in the above service-life group, the controller controls the notification device to notify that the life of the pressure roller has ended (in step S23). If the controller determines that the width of the sheet contained in the instruction is smaller than or equal to the smallest width of the sheets included in the above service-life group, the controller controls the notification device not to notify that the life of the pressure roller has ended (in step S24) and performs the image forming operation. Since the regions outside the sheet having the smallest width in the above service-life group become the non-sheet-passing regions, the temperatures of the pressure roller increase in these regions. Therefore, the controller determines whether the width of the sheet contained in the instruction to perform the image forming operation is larger than the smallest width of the sheets included in the above service-life group (in step S22).

Performing the image forming operation without replacing the pressure roller when the width of the sheet contained in the instruction is smaller than the smallest width of the sheets included in the above service-life group, as described above, can delay the replacement of the pressure roller, which reduces the service cost regarding the replacement of the pressure roller.

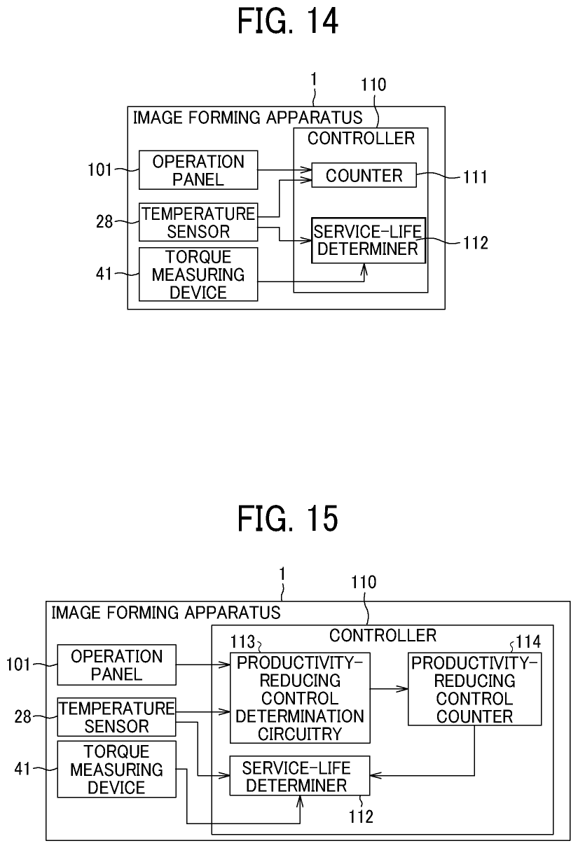

With reference to the functional block diagram in FIG. 14, the following describes a configuration in the image forming apparatus for performing the above-described determination of the end of life of the pressure roller.

As illustrated in FIG. 14, the image forming apparatus 1 includes a controller 110. The controller 110 includes a counter 111 and a service-life determiner 112.

The counter 111 counts the number of sheets passing through the fixing nip in each of the above-described service-life groups. Data on the number of sheets and the sheet width for forming the image are entered into the operation panel 101 and transmitted to the counter 111. In addition, the temperature detected by the temperature sensor 28 is input to the counter 111. Or, when an external device, such as a personal computer, sends the image forming apparatus 1 the instruction for the image forming operation, the controller 110 receives the instruction and transmits the data on the number of sheets and the sheet width included in the instruction to the counter 111. Based on the data, the counter 111 determines the service-life group to count the number of sheets, and counts the number of sheets in the service-life group.

The service-life determiner 112 determines whether the number of sheets in the service-life group counted by the counter 111 reaches the life determination number of sheets in order to determine whether the life of the pressure roller has ended. When the torque to rotate the pressure roller is considered to adjust the life determination number of sheets of the pressure roller, the torque measuring device 41 measures the torque and transmits the value of the torque to the service-life determiner 112. Based on the value of the torque, the service-life determiner 112 reduces the life determination number of sheets or the life determination distance. When the operation panel 101 is used as the notification device, the service-life determiner 112 sends the operation panel 101 an instruction to display the end of the life of the pressure roller.

FIG. 15 is a functional block diagram illustrating a configuration of an image forming apparatus according to a modification to determine the life of the pressure roller. In the configuration illustrated in FIG. 15, the controller 110 determines the end of the life of the pressure roller based on a parameter regarding the productivity-reducing control of the image forming apparatus.

In the modification illustrated in FIG. 15, the controller 110 does not include the counter 111 (see FIG. 14). Instead of the counter 111, the controller 110 includes a productivity-reducing control determiner 113 and a productivity-reducing control counter 114 and uses the productivity-reducing control determiner 113 and the productivity-reducing control counter 114 to determine the end of the life of the pressure roller.

The productivity-reducing control determiner 113 determines whether the productivity-reducing control is performed based on data, such as the temperature detected by the temperature sensor 28 or the number of sheets printed. When the productivity-reducing control determiner 113 determines to perform the productivity-reducing control, the productivity-reducing control determiner 113 inputs information regarding the productivity-reducing control to the productivity-reducing control counter 114. The productivity-reducing control counter 114 counts the number of times that the productivity-reducing control is performed, or measures and accumulates the duration for which the productivity-reducing control is performed. The productivity-reducing control counter 114 inputs the counted number of times that the productivity-reducing control is performed, or the accumulated duration for which the productivity-reducing control is performed, to the service-life determiner 112. The service-life determiner 112 determines whether the life of the pressure roller has ended based on the above-described information and the temperature detected by the temperature sensor 28.

The above-described embodiments are illustrative and do not limit this disclosure. It is therefore to be understood that within the scope of the appended claims, numerous additional modifications and variations are possible to this disclosure otherwise than as specifically described herein.

Applications of the embodiments of the present disclosure are not limited to the image forming apparatus including the fixing device as illustrated in FIG. 2. The embodiments of the present disclosure are also applicable to image forming apparatuses including the fixing device having one halogen heater 23 as illustrated in FIG. 16 or the fixing device having three or more halogen heaters 23.

The fixing device 20 illustrated in FIG. 18 includes a metal thermal conductor 39 inside the loop of the fixing belt 21. The metal thermal conductor 39 is disposed between the halogen heater 23 and the fixing belt 21. The halogen heater 23 heats the fixing belt 21 via the metal thermal conductor 39. Heating the fixing belt 21 via the metal thermal conductor 39 can uniformly heat the entire fixing belt 21. On the other hand, the fixing device 20 illustrated in FIG. 2 can shorten the time to heat the fixing belt 21 to a fixing temperature and be smaller than that of the fixing device illustrated in FIG. 18, which enables shortening a first print output time and reducing the cost.

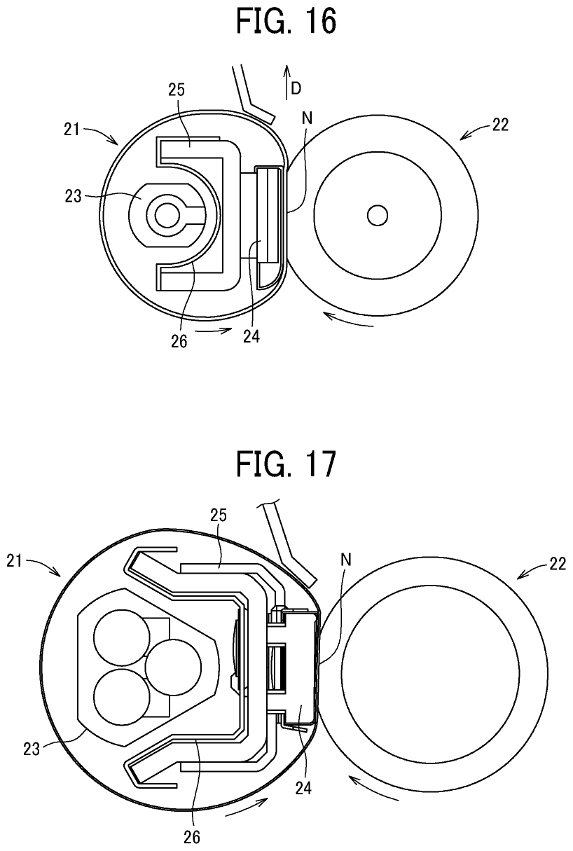

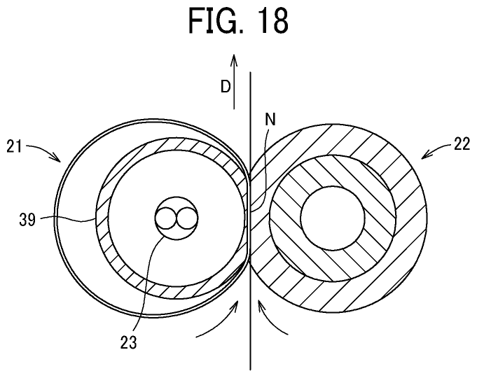

The above-described embodiments to determine the end of the life of the pressure roller 22 can be applied to the fixing devices illustrated in FIGS. 16 to 18. As a result, the end of the life of the pressure roller 22 can be appropriately determined.

The image forming apparatus according to the present embodiments of the present disclosure is applicable not only to the color image forming apparatus illustrated in FIG. 1 but also to a monochrome image forming apparatus, a copier, a printer, a facsimile machine, or a multifunction peripheral including at least two functions of the copier, printer, and facsimile machine. The image forming apparatus applying the present embodiments is not limited to the electrophotographic image forming apparatus and may be applied to, for example, an ink jet type image forming apparatus. In this case, the life of the pressure roller disposed in a dryer can be suitably determined.

The sheet is one example of a recording medium. The recording medium may be a sheet of plain paper, thick paper, thin paper, a postcard, an envelope, coated paper, art paper, tracing paper, overhead projector (OHP) sheet, plastic film, prepreg, or copper foil.

An image forming apparatus (1) includes: a rotating member (21); a pressure roller (22) pressed against the rotating member (21) to form a nip between the rotating member (21) and the pressure roller (22) to convey a medium in a conveyance direction; a heater (23) in the rotating member (21) to heat the rotating member (21); a temperature sensor (28) disposed, in a width direction orthogonal to the conveyance direction, outside a passing region through which a medium having a smallest usable width in the image forming apparatus (1) passes; circuitry (110) configured to: store width groups of the media defined by a width of the medium in the width direction; determine the width groups to which the width of the medium passing through the nip belongs; count a number of media passing through the nip in each of the width groups; or measure a passing distance of media passing through the nip in the conveyance direction in each of the width groups; and set a service life of the pressure roller (22) based on: a temperature detected by the temperature sensor (28); and one of: the number of media counted; or the passing distance measured.

The circuitry (110) is further configured to: set service-life groups defined by combinations of: ranges of temperatures detected by the temperature sensor (28); and the width groups, and set, in each of the service-life groups, one of: a service-life sheet count of the media; or a service-life conveyance distance of the media, regarding the service life of the pressure roller (22); and determine that the service life of the pressure roller (22) has ended, when the number of the media reaches the service-life sheet count in any one of the service-life groups, or when the passing distance reaches the service-life conveyance distance in any one of the service-life groups.

The circuitry (110) is further configured to: set a service-life value of the pressure roller (22) set in each of the width groups; weight, for each width groups, the number of the media counted; or the passing distance of the media measured, based on a temperature detected by the temperature sensor (28); cumulatively summing the number of the media or the passing distance of the media weighted to calculate a weighted cumulative value; and determine that the service life of the pressure roller (22) has ended when the weighted cumulative value reaches the service-life value in any one of the width groups.

The image forming apparatus (1) further includes: multiple heaters (23A, 23B) including the heater (23), wherein the multiple heaters (23A, 23B) have main heat generation regions (23A1, 23B1) arranged at different positions in the width direction.

The image forming apparatus (1) further includes: an image forming device to form an image on the medium at an image formation rate, wherein the controller (110) (circuitry) is further configured to, only when a maximum image formation rate is equal to or larger than a predetermined threshold, determine the service life of the pressure roller (22) based on: the temperature detected by the temperature sensor (28); and one of: the number of media counted; or the passing distance measured.

The image forming apparatus (1) further includes: a torque measuring device (41) to detect a torque to rotate the pressure roller (22), wherein the controller (110) (circuitry) is further configured to change the service life of the pressure roller (22) based on the torque detected by the torque measuring device.

The image forming apparatus (1) further includes: an image forming device to form an image on the medium, wherein the controller (110) (circuitry) is further configured to: set, in each of the width groups: a service-life sheet count of the media; or a service-life conveyance distance of the media; determine that the service life of the pressure roller (22) has ended, when the number of the media reaches the service-life sheet count in any one of the width groups, or when the passing distance reaches the service-life conveyance distance in any one of the width groups; and allow the image forming device to form the image on the medium having a width smaller than a smallest width in one of the width groups, after the controller (110) determines that the service life of the pressure roller (22) has ended.

The image forming apparatus (1) further includes: a notification device (101), wherein the controller (110) (circuitry) is further configured to: control the notification device (101) to notify that the service life of the pressure roller (22) has ended: after the controller (110) (circuitry) determines that the service life of the pressure roller (22) has ended; and after the controller (110) (circuitry) receives an instruction to form the image on the medium having a width equal to or larger than the smallest width in one of the width group.

An image forming apparatus (1) includes: an image forming device to form an image on the medium to perform an image forming operation at an image forming rate, a rotating member (21); a pressure roller (22) pressed against the rotating member (21) to form a nip between the rotating member (21) and the pressure roller (22) to convey a medium in a conveyance direction; a heater (23) in the rotating member (21) to heat the rotating member (21); a temperature sensor (28); a controller (110) (circuitry) configured to: determine whether a frequency of the image forming operation is larger than a predetermined threshold; limit the image forming rate in response to a determination that the frequency is larger than the predetermined threshold; accumulate one of: a number of times the controller (110) limits the image formation rate; and a duration for which the controller (110) limits the image formation rate; and determine whether a service life of the pressure roller (22) has ended based on: a temperature detected by the temperature sensor (28); and one of the number of times and the duration.

Aspects of the present disclosure are, for example, as follows.

### First Aspect

In a first aspect, an image forming apparatus includes a rotating member, a pressure roller, a heater, a temperature sensor, and a controller. The pressure roller presses against the rotating member to form a nip between the rotating member and the pressure roller. The heater generates heat by itself to heat the pressure roller. A recording medium passes through the nip to be heated. In a width direction of the recording medium, the temperature sensor is disposed outside a region, through which a recording medium with a minimum width in recording media that is usable in the image forming apparatus passes. The controller counts the numbers of the recording media passing through the nip in each of sizes of the recording media in the width direction or accumulates distances of the recording media in a recording medium conveyance direction in each of sizes of the recording media in the width direction. The controller changes the life of the pressure roller based on a temperature detected by the temperature sensor and one of the counted number and the accumulated distance.

### Second Aspect

In a second aspect, the controller in the image forming apparatus according to the first aspect sets service-life groups due to combinations of temperatures detected by the temperature sensor and sizes in the width direction, the sizes of the recording media passing through the nip. The controller sets a life determination number of sheets of the pressure roller or a life determination distance of the pressure roller in each of the service-life groups. The controller determines that the life of the pressure roller has ended when the counted number reaches the life determination number of recording media in any one of the service-life groups or when the accumulated distance reaches the service-life determination distance in any one of the service-life groups.

### Third Aspect

In a third aspect, the controller in the image forming apparatus according to the first aspect sets a service-life value of the pressure roller in each of sizes in the width direction, the sizes of the recording media passing through the nip. The controller weights, in each of sizes of the recording media in the width direction, the number of the recording media passing through the nip using the temperature detected by the temperature sensor. Or the controller weights, in each of sizes of the recording media in the width direction, the distance of the recording medium using the temperature detected. The controller accumulates the weighted number of recording media or the weighted distances to calculate a weighted and accumulated value. The controller determines that the life of the pressure roller has ended when the weighted and accumulated value in any one of the sizes of the recording media in the width direction reaches the service-life value.

### Fourth Aspect

In a fourth aspect, the image forming apparatus according to any one of the first to third aspects includes multiple heaters including the heater. Ranges of the multiple heaters in the width direction of the recording medium are different.

### Fifth Aspect

In a fifth aspect, only when the largest image formation rate of the image forming apparatus is equal to or larger than a predetermined image formation rate, the controller in the image forming apparatus according to any one of the first to fourth aspects determines that the life of the pressure roller has ended based on the temperature detected by the temperature sensor and one of the counted number and the accumulated distance.

### Sixth Aspect

In a sixth aspect, the image forming apparatus according to any one of the first to fifth aspects includes a driver to transmit a driving force to the pressure roller and rotate the pressure roller and a torque measuring device to detect a torque to rotate the pressure roller. The controller changes the life of the pressure roller based on the torque detected by the torque measuring device.

### Seventh Aspect

In a seventh aspect, the controller in the image forming apparatus according to any one of the first to sixth aspects sets a life determination number of the recording media passing through the nip in each of the sizes of the recording media in the width direction or a life determination distance in each of the sizes in the width direction of the recording media.

The controller determines that the life of the pressure roller has ended when the counted number reaches the life determination number of sheets in any one of the sizes of the recording media in the width direction or when the accumulated distance reaches the service-life determination distance in any one of the sizes of the recording media in the width direction.

Even when the counted number reaches the life determination number of sheets in any one of the sizes of the recording media in the width direction or even when the accumulated distance reaches the service-life determination distance in any one of the sizes of the recording media in the width direction, the controller sets the image forming apparatus to be able to form an image on the recoding medium having a width smaller than a width of the recording medium in which the controller determine that the life of the pressure roller has ended.

### Eighth Aspect

In an eighth aspect, the controller in the image forming apparatus according to the seventh aspect controls a notification device to notify that the life of the pressure roller has ended when an instruction is transmitted to perform an image forming operation on the recording medium having a size larger than the width of the recording medium in which the controller determines that the counted number or the accumulated distance reaches the life determination number of sheets or the life determination distance.

### Ninth Aspect

In a first aspect, an image forming apparatus includes a roller, a pressure roller, a heater, a temperature sensor, and a controller. The pressure roller presses against the rotating member to form a nip between the rotating member and the pressure roller. The heater generates heat by itself to heat the pressure roller. A recording medium passes through the nip to be heated.

The controller limits an image formation rate when a frequency of the recording medium in which an image is formed is large. The controller determines the life of the pressure roller based on either the number of times the controller limits the image formation rate or the duration during which the controller limits the image formation rate, and a temperature detected by the temperature sensor.

### Tenth Aspect

In a tenth aspect, the image forming apparatus according to the ninth aspect includes multiple heaters including the heater. Ranges of the multiple heaters in the width direction of the recording medium are different.

### Eleventh Aspect

In an eleventh aspect, only when the largest image formation rate of the image forming apparatus is equal to or larger than a predetermined image formation rate, the controller in the image forming apparatus according to ninth or tenth aspect determines that the life of the pressure roller has ended based on either the number of times the controller limits the image formation rate or the duration for which the controller limits the image formation rate, and the temperature detected by the temperature sensor.

### Twelfth Aspect

In a twelfth aspect, the image forming apparatus according to any one of the ninth to eleventh aspects includes a driver to transmit a driving force to the pressure roller and rotate the pressure roller and a torque measuring device to detect a torque to rotate the pressure roller. The controller changes the life of the pressure roller based on the torque detected by the torque measuring device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a rotating member;
a pressure roller pressed against the rotating member to form a nip between the rotating member and the pressure roller to convey a medium in a conveyance direction;
a heater in the rotating member to heat the rotating member;
a temperature sensor disposed, in a width direction orthogonal to the conveyance direction, outside a passing region through which a medium having a smallest usable width in the image forming apparatus passes; and
a circuitry configured to:
store width groups of media defined by a width of the medium in the width direction;
determine the width groups to which the width of the medium passing through the nip belongs;
count a number of media passing through the nip in each of the width groups; or
measure a passing distance of media passing through the nip in the conveyance direction in each of the width groups; and
set a service life of the pressure roller based on:
a temperature detected by the temperature sensor; and
one of:
the number of media counted; or
the passing distance measured.

2. The image forming apparatus according to claim 1,
wherein the circuitry is further configured to:
set service-life groups defined by combinations of:
ranges of temperatures detected by the temperature sensor; and
the width groups, and
set, in each of the service-life groups, one of:
a service-life sheet count of the media; or
a service-life conveyance distance of the media,
regarding the service life of the pressure roller; and
determine that the service life of the pressure roller has ended,
when the number of the media reaches the service-life sheet count in any one of the service-life groups, or
when the passing distance reaches the service-life conveyance distance in any one of the service-life groups.

3. The image forming apparatus according to claim 1,
wherein the circuitry is further configured to:
set a service-life value of the pressure roller set in each of the width groups;
weight, for each width groups,
the number of the media counted; or
the passing distance of the media measured, based on a temperature detected by the temperature sensor;
cumulatively sum the number of the media or the passing distance of the media weighted to calculate a weighted cumulative value; and
determine that the service life of the pressure roller has ended when the weighted cumulative value reaches the service-life value in any one of the width groups.

4. The image forming apparatus according to claim 1, further comprising
multiple heaters including the heater,
wherein the multiple heaters have main heat generation regions arranged at different positions in the width direction.

5. The image forming apparatus according to claim 1, further comprising:
an image forming device to form an image on the medium at an image formation rate,
wherein the circuitry is further configured to, only when a maximum image formation rate is equal to or larger than a predetermined threshold,
determine the service life of the pressure roller based on:
the temperature detected by the temperature sensor; and
one of:
the number of media counted; or
the passing distance measured.

6. The image forming apparatus according to claim 1, further comprising:
a torque measuring device to detect a torque to rotate the pressure roller,
wherein the circuitry is further configured to change the service life of the pressure roller based on the torque detected by the torque measuring device.

7. The image forming apparatus according to claim 1, further comprising:
an image forming device to form an image on the medium,
wherein the circuitry is further configured to:
set, in each of the width groups:
a service-life sheet count of the media; or
a service-life conveyance distance of the media;
determine that the service life of the pressure roller has ended,
when the number of the media reaches the service-life sheet count in any one of the width groups, or
when the passing distance reaches the service-life conveyance distance in any one of the width groups; and
allow the image forming device to form the image on the medium having a width smaller than a smallest width in one of the width groups, after the circuitry determines that the service life of the pressure roller has ended.

8. The image forming apparatus according to claim 7, further comprising:
a notification device,
wherein the circuitry is further configured to:
control the notification device to notify that the service life of the pressure roller has ended:
after the circuitry determines that the service life of the pressure roller has ended; and
after the circuitry receives an instruction to form the image on the medium having a width equal to or larger than the smallest width in one of the width groups.

9. An image forming apparatus comprising:
an image forming device to form an image on a medium to perform an image forming operation at an image forming rate;
a rotating member;
a pressure roller pressed against the rotating member to form a nip between the rotating member and the pressure roller to convey a medium in a conveyance direction;
a heater in the rotating member to heat the rotating member;
a temperature sensor; and
a circuitry configured to:
determine whether a frequency of the image forming operation is larger than a predetermined threshold;
limit the image forming rate in response to a determination that the frequency is larger than the predetermined threshold; and
accumulate one of:
a number of times the circuitry limits an image formation rate; and
a duration for which the circuitry limits the image formation rate; and
determine whether a service life of the pressure roller has ended based on:
a temperature detected by the temperature sensor; and
one of the number of times and the duration.
